(19) United States
(12) Patent Application Publication
(10) Pub. No.: US 2002/0091774 A1
(43) Pub. Date: Jul. 11, 2002

(54) Method and system for retrieving electronic mail for a plurality of users over a single device

(76) Inventors: Kokoro Imamura, La Jolla, CA (US); Srikant Char, Poway, CA (US)

Correspondence Address: Stuart H. Mayer, Esq., Mayer Fortkort & Williams PC, Suite 250, 200 Exectuive Drive, West Orange, NJ, 07052, US

(21) Appl. No.: 09/909,151

(22) Filed: Jul. 19, 2001

Related U.S. Application Data
(60) Provisional application No. 60/260,118, filed on Jan. 8, 2001.

(51) Int. Cl. G06F 15/16; G09G 5/00

(52) U.S. Cl. 709/206; 709/203; 345/750

(57) ABSTRACT

An Internet access device employs a method for managing electronic mail messages for multiple users of the device. When one user retrieves his or her messages over a distributed computer network, such as the Internet, the device also retrieves status information regarding the remaining users' unread email messages. This enables the device to inform the other users as to their unread email. A computer-readable storage medium for storing data for access by a computer program being executed on a user interface device includes at least two data structures. A first data structure stored on the medium provides for retrieving electronic mail messages addressed to one of the users. A second data structure stored on said medium provides for retrieving status information regarding any unread electronic mail messages addressed to any remaining users. A system containing a user interface for recipients of electronic mail messages includes a processing unit, system memory, an I/O device, a system bus and an email program module. The system bus couples together the processing unit, system memory, and input/output device. The electronic mail program module is stored in the system memory and is operative to retrieve over a distributed computer network electronic mail messages addressed one of the users, as well as to retrieve status information regarding any unread electronic mail messages addressed to any other users.

### RELATED APPLICATIONS

This application claims priority to U.S. Provisional Application No. 60/260,118, filed on Jan. 5, 2001 by the same inventors.

### COPYRIGHT NOTICE

A port of the disclosure of this patent document contains material that is subject to copyright protection. The copyright owner has no objection to the facsimile reproduction of the patent document or the patent disclosure, as it appears in the U.S. Patent & Trademark Office patent file or records, but otherwise reserves all copyright rights whatsoever.

### FIELD OF THE INVENTION

The present invention relates generally to electronic mail systems and more particularly to an electronic mail system used by multiple users of a personal computer or other devices providing network connectivity.

### BACKGROUND OF THE INVENTION

Electronic mail (“e-mail”) is quickly becoming a standard mode of communication in the 1990s. E-mail's popularity can be attributed to the ease with which e-mail messages may be transmitted, and the speed with which a transmitted message arrives at the intended destination. For example, to transmit a single e-mail message, the sender typically types a message and addresses the message with the recipient's e-mail address. When the message is complete, the sender commands the e-mail software to transmit the message, and the message is then delivered over a computer network such as the Internet. The delivered message is quickly received by the recipient's computer.

Before two computers can exchange e-mail with one another, they must agree on a common set of rules or agreements describing how they are to communicate. These rules are collectively referred to as a protocol. One conventional e-mail exchange protocol, which is widely used between computers exchanging e-mail over the Internet, is SMTP (“simple mail transfer protocol”). SMTP prescribes the series of commands computers exchanging e-mail are to use when communicating with one another. Other exemplary messaging protocols that support e-mail messages include the Internet Message Access Protocol (IMAP) and version 3.0 of the Post Office Protocol (POP3). IMAP defines a method of accessing electronic mail or bulletin board messages that are kept in a message store on a remote mail server. IMAP permits an e-mail client program to access remote message stores as if they were local. Messages stored on an IMAP server can be easily manipulated by a user who uses multiple computers (e.g., a workstation at the office and a notebook on the road) without requiring the user to transfer messages or files back and forth between his or her computers. POP3 does not have as much flexibility as IMAP. Specifically, POP3 typically requires the deletion of messages from the server after downloading these messages to a client. So, the user is unable to maintain messages on the server if the user so desires.

Unfortunately, the e-mail recipient has no way of knowing when e-mail has reached the e-mail server except by checking his mailbox. This can be a time consuming and frustrating task since there is often no e-mail in the mailbox and the time spent checking has been wasted. To remedy this shortcoming, many electronic mail systems added the capability to notify the user that new e-mail has been received when he or she logs on to the network. For example, some electronic mail systems alert users of newly received electronic mail by causing an audible tone to be played on their computer. Alternatively, some systems place a small message on the recipient's display indicating the presence of a new message and in some case also indicating the sender of the e-mail message. Obviously, this notification scheme only works when the user is logged onto the network.

In many cases a given computer will be used by more than one individual to check his or her e-mail. Each individual is required to separately log onto the network to access their messages, or even to be notified that a message has been received. This can be particularly problematic as the number of individuals using a single computer increases. Moreover, this problem may be exacerbated as individuals begin to access their e-mail on devices other than personal computers. For example, Internet appliances, whose primary function is to provide connectivity to the Internet and not to perform other traditional computing tasks, are growing in popularity. If such an appliance is situated in a residence and treated as any other household appliance, user demand simply for the purpose of logging onto a network to check for e-mail messages may limit individuals' access to the appliance, causing the individual to waste yet even more time.

The present invention is therefore directed to the problem of simplifying the ease of access of one's email in a multi-user environment.

### SUMMARY OF THE INVENTION

The present invention solves this and other problems by providing inter alia a method for managing electronic mail messages to be received over a distributed computer network by multiple users, in which some email messages are retrieved over the distributed computer network, which retrieved email messages are addressed to a first one of the users, and status information regarding any unread electronic mail messages is retrieved over the distributed computer network, which unread electronic mail messages are addressed to any remaining users.

According to another aspect of the present invention, a computer-readable storage medium for storing data for access by a computer program being executed on a user interface device includes at least two data structures. A first data structure stored on the medium provides for retrieving electronic mail messages addressed to one of the users. A second data structure stored on said medium provides for retrieving status information regarding any unread electronic mail messages addressed to any remaining users.

According to yet another aspect of the present invention, a system containing a user interface for recipients of electronic mail messages includes a processing unit, system memory, an I/O device, a system bus and an email program module. The system bus couples together the processing unit, system memory, and input/output device. The electronic mail program module is stored in the system memory and is operative to retrieve over a distributed computer network electronic mail messages addressed one of the users, as well as to retrieve status information regarding any unread electronic mail messages addressed to any other users.

### BRIEF DESCRIPTION OF THE DRAWINGS

FIG. 1 shows a client-server architecture in which the present invention may be employed.

FIG. 2 shows a block diagram of an illustrative user interface device that may be employed in connection with the present invention.

FIG. 3 shows a block diagram of an illustrative mail service system that may be employed in connection with the present invention.

FIG. 4 shows pertinent components of the mail service system and the user interface device, seen in FIGS. 3 and 4, respectively, for the purpose of illustrating the communication process between them.

FIG. 5 is a flowchart illustrating a representative example of a conventional communication session between the electronic mail system and the user interface device.

FIG. 6 shows one embodiment of a window that may be displayed on the user interface device by the message manager of the present invention.

FIG. 7 is a flowchart illustrating a representative example of a communication session in accordance with the present invention between an electronic mail system and a user interface device.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

### System Overview

The present invention finds application in Sony's eVilla Network Entertainment Center, which provides Internet access for entertainment and communication without the complications of a computer. It is conveniently packaged with hardware, software and a dedicated Internet Service Provider (ISP). The eVilla is designed with the Internet in mind with email, a web-friendly display, browser, and preloaded multimedia software.

The eVilla includes a display depicting the way the Internet was meant to be viewed. A large 15″ (14″ viewable) FD Trinitron® Portrait View display combines high-resolution with up to ⅓ more viewing space, reducing unnecessary scrolling.

The eVilla is easily powered on. With the touch of a button, hassles waiting to boot-up are reduced since email and web content are updated daily.

Software management is simplified. All software necessary to operate eVilla is pre-loaded and will be managed for the user—no hassles, just fun.

A powerful and elegant Graphical User Interface (GUI) is provided. The GUI is simple, uncluttered, and intuitive—easy enough for the Internet beginner, yet strong enough for the power user.

Automatic Email and Web Content Updates are provided. Daily automatic updates enable one to read and compose email and access customized web content in an offline mode with the touch of a button while one's telephone line remains open to callers. Of course, one can always go on-line whenever one prefers.

Multimedia-Internet Entertainment is made easy. Plug-in support and organized channels simplifies listening to Internet music and radio, and viewing images and video. Built-in stereo speakers and audio output jack helps you get the most from Internet radio and streaming audio.

Fun Communication is possible. One can view and send email with pictures, video, and audio attachments.

Multiple users can enjoy this device. Each eVilla on-line account allows for up to four unique users including private email addresses, separate bookmarks, cookies and preferences.

The eVilla comes with a Memory Stick® Media Slot. With 10 million Memory Stick media users and counting, enjoy the most convenient way to store and share digital information.

Multiple USB ports are provided. The device supports multiple printers and external storage devices through at least two USB ports.

A V.90 Modem and Ethernet Port are provided. Connection to the Internet is possible using a regular telephone line. An Ethernet port may also be included for broadband connectivity.

The device operates silently. No fan eliminates noise.

### Exemplary Embodiment

The present invention provides a system for managing messages communicated within a client-server architecture so that multiple e-mail recipients can be notified if unread messages have been received by the server. In an exemplary embodiment, the invention is incorporated into an e-mail application program such as represented by Microsoft Corporation's Outlook, International Business Machines' V-Net System, and Apple Computer's AppleLink. The present invention, namely a message manager program module (“message manager”), allows an individual user who contacts the server to retrieve his or her e-mail, to further retrieve status information regarding unread messages addressed to other users of the client.

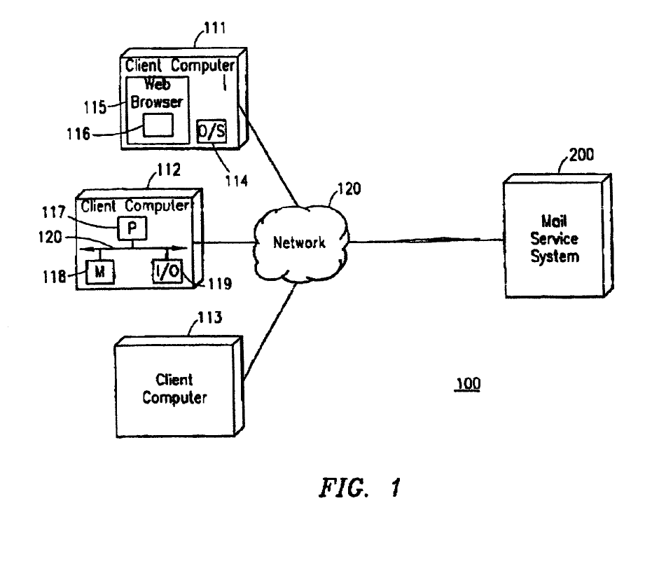

The system architecture of one embodiment of the present invention is illustrated with reference to FIGS. 1-3. As shown in FIG. 1, the apparatus of the present invention comprises user interface devices 111-113 and mail service system 200. User interface devices 110-113 and mail service system 200 are connected via a distributed computer network 120, using, for example, a public switched phone network (not shown), such as those provided by a local or regional telephone operating company. Connection may also be provided by dedicated data lines, cellular, Personal Communication Systems (“PCS”), microwave, or satellite networks. Distributed computer network 120 is a collection of individual computers and computer networks that are linked together by a set of standard protocols. One example of a distributed network is the Internet, which employs standard protocols. In particular, higher level protocols, such as HyperText Transfer Protocol (HTTP) and File Transfer Protocol (FTP), communicate at the application layer, while lower level protocols, such as Transmission Control Protocol/internet Protocol (TCP/IP) operate at the transport and network levels.

The mail service system 200 can be implemented as one or more server computers connected to each other either locally, or over large geographies. A server computer, as the name implies, is configured to execute server software programs on behalf of user interface devices 111-113, which function as clients. Sometimes, the term “server” can mean the hardware, the software, or both because the software programs may dynamically be assigned to different server computers depending on load conditions. Servers typically maintain large centralized data repositories for many users.

In the mail system 200, the servers are configured to maintain user accounts, to receive, filter, and organize mail messages so that they can readily be located and retrieved, no matter how the information in the messages is encoded. If the distributed computer network 120 over which mail system 200 operates is the Internet, the servers may employ conventional e-mail protocols, such as the aforementioned SMTP, IMAP, and POP3, which work in conjunction with a user's e-mail program and defines the control messages used by two computers to exchange e-mail messages. Such controls include verification of proper connection, identification of sender, negotiation of transmission parameters, and message transmission. The protocols are responsible for: (1) sending mail created by a local user to another computer; and (2) receiving mail from other computers on the network and transferring it to the local user's e-mail program.

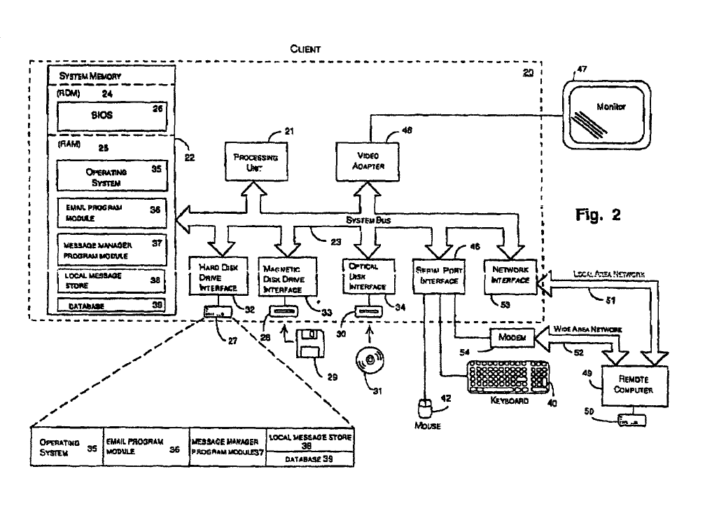

FIG. 2 shows a block diagram of an illustrative user interface device 300 that may be employed in connection with the present invention. While the device 300 is illustrated as a general purpose computer, those or ordinary skill in the art will recognize that the user interface device may be any device that can communicate with, and receive information from, a distributed computer network such as the Internet. For example, the user interface device 300 may be a web-enabled television, telephone or other online appliance providing network connectivity.

User interface device 300 may represent any or all of the user interface devices 111-113 illustrated in FIG. 1. The user interface device 300 includes a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the user interface device 300 is stored in ROM 24. The user interface device 300 further includes a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by at hard disk drive interface 32, a magnetic disk drive interface 33, and an optical drive interface 34, respectively. The drives and their associated computer-readable media provide nonvolatile storage for the user interface device 300. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an e-mail program module 36, other program modules, such as a message manager program module 37, a local message store 38, and a database 39 for supporting e-mail applications. A user may enter commands and information into the user interface device 300 through a keyboard 40 and pointing device, such as a mouse 42. Other input devices (not shown) may include a pen, touch-operated device, microphone joystick, game pad, satellite dish, scanner, or the like. These and other input devices are often connected to the processing unit 21 through a serial port interface 46 that is coupled to the system bus, but may be connected by other interfaces, such as a game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The user interface device 300 typically operates in a networked environment using logical connections to one or more remote computers, such as a remote computer 49, seen in FIG. 2. The remote computer 49 may be an e-mail server, as described above in connection with FIG. 1, a file server, a router, a peer device or other common network node, and typically includes many or all of the elements described relative to the user interface device 300, although only a memory storage device 50 has been illustrated in FIG. 2. The logical connections depicted in FIG. 2 include a local area network (LAN) 51 and a wide area network (WAN) 52. Such networking environments are commonplace in offices, enterprise-wide computer networks, intranets and the Internet.

When used in a LAN networking environment the user interface device 300 is connected to the LAN 51 through a network interface 53. When used in a WAN networking environment, the user interface device 300 typically includes a modem 54 or other means for establishing communications over a distributed network such as the Internet. The modem 54, which may be internal or external, is connected to the system bus 23 via the serial port interface 46. In a networked environment, program modules depicted relative to the user interface device 300 or portions thereof, may be stored in the remote memory storage device. It will be appreciated that the network connections shown are exemplary and other means of establishing a communications link between the computers may be used.

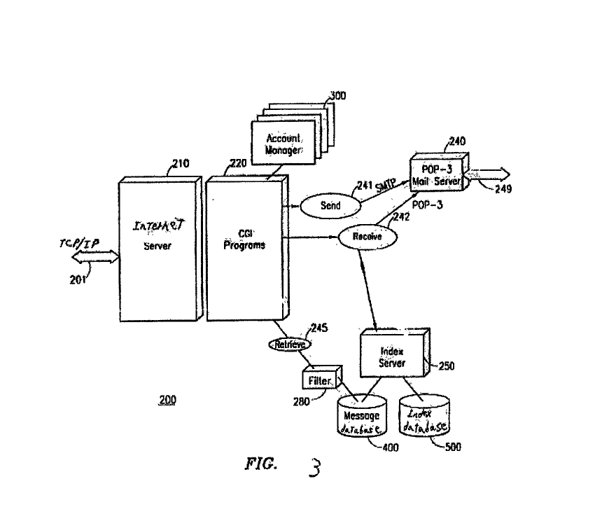

FIG. 3 shows a block diagram of an illustrative mail service system 200 that may be employed in connection with the present invention. The mail service system 200 includes a front-end Internet server 210 that interacts with a back-end common gateway interface (CGI) programs 220. The interface 200 communicates with an account manager 300, a mail server 240 such as an STMP mail server, and an index server 250. The CGI 220 could be implemented in a number of different ways. For example, code can be directly added to the Internet server 210, or extensions can be added to the Netscape Server Application Programming Interface (NSAPI) from Netscape. The top-level functions of the system 200 include send mail 241 and receive mail 242. The mail server system 200 receives (242) new mail messages by communicating with the mail server 240 using a messaging protocol such as POP-3, IMAP, or the like. Messages can be sent (241) using the same or a different protocol. Different servers can be used for the processes that implement the functions 241 and 242.

The mail server 240 is used to send and receive mail messages to and from other servers connected to the network. The index server 250 maintains mail messages in message database 400 and may also maintain a full-text index to the messages in index database 500. The CGI 220 also interacts with the messages database 400 via a filter 280 for mail message retrieval.

The account manager 300 maintains account information for users who are allowed to have access to the mail system 200. Information maintained for each account can include: mail-box address, e.g., in the form of a “Post Office Protocol” (POP-3) address, a user password, and user preferences. The passwords are used to authenticate users. User preferences specify the appearance and functioning of the user interface to the mail service as implemented on the user interface devices. The account manager 300 can generate a new account, or delete an existing account. The account is generated for a user by specifying the user name and password.

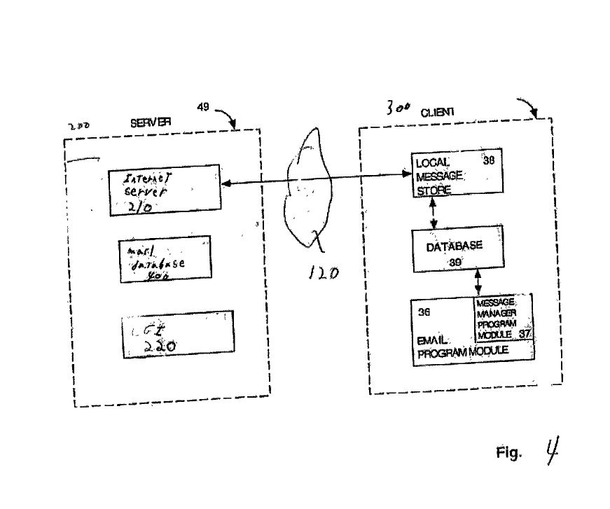

FIG. 4 will be used to illustrate the communication process between the mail service system 200 and one of the user interface devices. FIG. 4 only shows the pertinent components of the mail service system 200 and the user interface device 300, which have been more fully described in connection with FIGS. 2 and 3. Accordingly, in connection with mail service system 200, FIG. 4 depicts Internet server 210, mail database 400, and CGI 220. In connection with the user interface device 300, FIG. 4 depicts local message store 38, database 39, e-mail program module 36, and message manager program module 37 for facilitating message management and operation of the database 39.

The mail service system 200 houses any e-mail messages from clients in the mail database 400 while awaiting transmission to an appropriate destination. The Internet server 210 forwards messages over the distributed network 120 from a sender client (not shown) to the user interface device 300, upon request by the user interface device 300. The CGI 130 typically facilitates the management of incoming and outgoing messages on the server. When a request for a message is made by the user interface device 300 to the mail service system 200, the Internet server 210 on the mail service system 200 responds by retrieving the message from the mail database 400 on the mail service system 200 and by transmitting the message over the distributed network 120 to the user interface device 300. The message is then downloaded into the local message store 38 located in the user interface device 300. The local message store 38 houses all downloaded messages from the mail service system 200.

During the download operation, data fields are populated within the database 39 with message-related information associated with the downloaded message. The information includes a unique identifier for identifying the message, a session identifier for indicating the particular order in which the message is retrieved from the system 200, a message size and other message-related information. The e-mail program module 36 provides facilities for creating, addressing, sending, receiving, and forwarding messages, while the message manager program module 37 manages messages during download and deletion operations utilizing the database 39.

With respect to the exemplary embodiment, the user interface device 300 provides two modes of operation in connection with the mail service system 200. These modes are a default mode and a “leave on server” mode. In the default mode, the user interface device 300 sends a delete command to the mail service system 200 to delete a message from the mail service system 200 after the message has been downloaded to the user interface device 300. In the “leave on server” mode, the client does not send a delete command to the mail service system 200 after the message has been downloaded to the user interface device 300, thereby allowing the message to remain on the mail service system 200 although the message has been downloaded. The mode of operation is generally determined based on user-preferences that are selected in e-mail program module 36. Advantageously, the present invention optimizes the management of messages when the user interface device 300 is in the “leave on server” mode.

In accordance with the present invention, if two or more individuals are regular users of a given user interface device, they may be recorded as registered users by e-mail program module 36. When a registered user logs onto the distributed computer network to access e-mail, the user has the option of also retrieving status information regarding the e-mail of the other registered users. For example, when a user retrieves his or her e-mail, the system 200 may download to the user interface device the number of unread messages that are being stored for the remaining registered user. The display of the user interface device may show the number of unread messages for each registered user.

Accordingly, the present invention allows one of the registered users, who logs onto the network to check his or her e-mail, to receive notification of unread e-mails for all the other registered users. As a result, there is no need for each and every user to log onto the network simply to determine if the user has any unread e-mails, which advantageously saves time and increases the availability of the user interface device for other tasks.

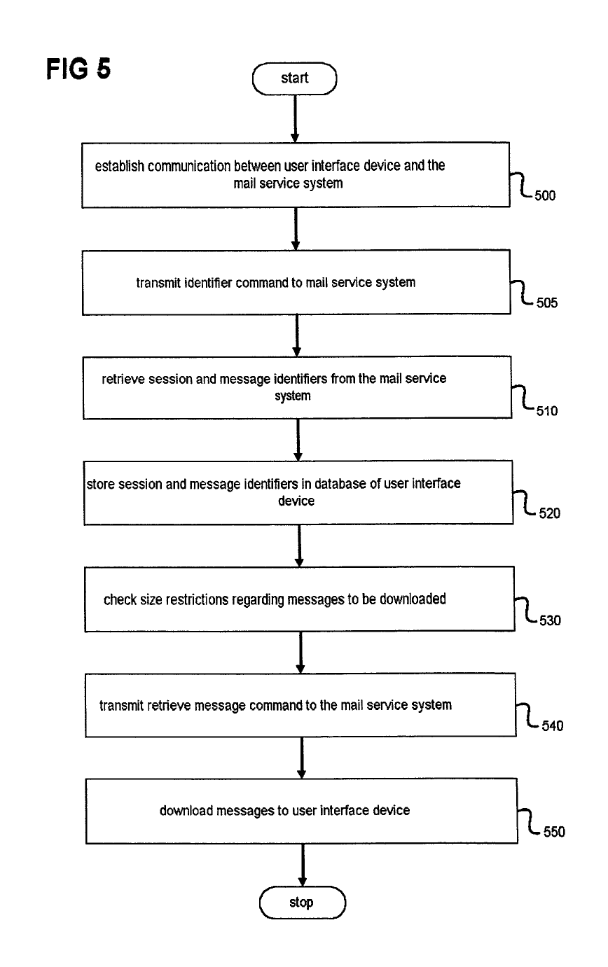

FIG. 5 is a flowchart illustrating a representative example of a communication session between mail system 200 and user interface device 300. In this example, two or more users are assumed to have previously been recorded as registered users in e-mail program module 36. Each user is presumed to have established an e-mail account with a unique address and password. The process begins at step 500 by establishing a connection between the user interface device 300 and mail service system 200. A user desiring to check her e-mail messages is typically prompted by the e-mail program module 36 to enter a password for access to the e-mail messages. In an initial download operation, user interface device 300 at step 505 transmits an identifier command to system 200, which is a request for identification information associated with a message. Each message has its own unique identifier to identify the message. At step 510, in response to the identifier command, the user interface device 300 retrieves from mail system 200 a session identifier and the requested message identifier for the first message on the system 200. The session identifier is indicative of the particular order in which the message is retrieved from the system 200 during a particular download operation. The message and session identifiers are stored in database 39 at step 520. If there are more messages on the system 200, this process is repeated for the additional messages to complete the initial download operation. Once the message and session identifiers have been populated in the database 39 for each message, the user interface device 300 checks for a size restriction in connection with downloading messaging from the mail system 200 at step 530. A size restriction for downloading messages from the system 200 can be set at any time based on user-preference. In this example, the user interface device 300 does not find a size restriction set by the user. Consequently, at step 540 the user interface device 300 transmits a retrieve command to the mail system 200. The retrieve command is a request to retrieve a message from the system 200 into the local message store 38 of the client. Each message is then downloaded into the local message store 38 at step 550.

Once the user's messages have been retrieved, the user may further download status information regarding the e-mail of other registered users. In a default mode of operation status information regarding e-mail for other registered users is automatically downloaded from mail server system 200 to database 39. In other embodiments of the invention the user is given the option to receive such status information.

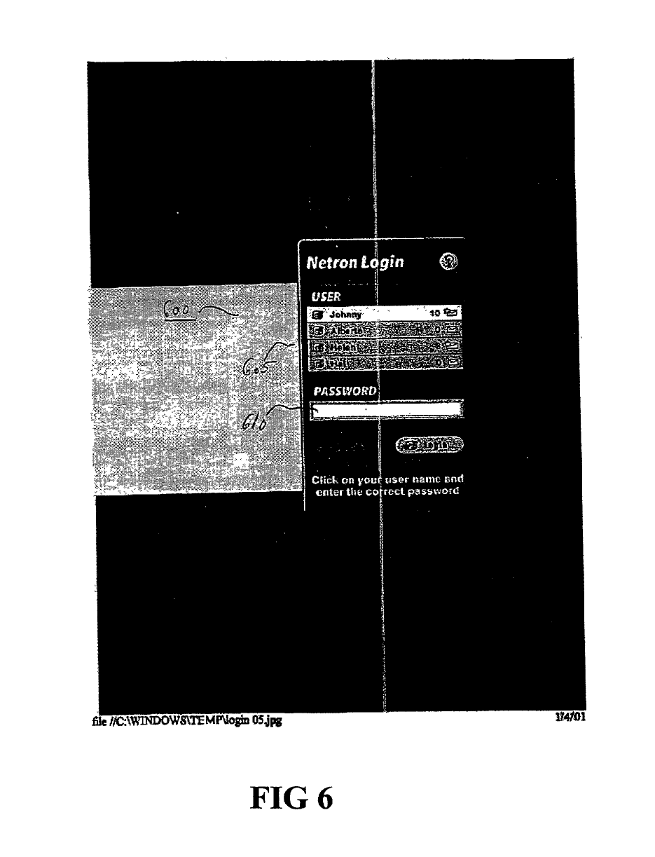

FIG. 6 shows one embodiment of a window 600 that may be displayed on the user interface device 300 for facilitating the practice of the present invention. The window 600 includes the names 605 of the registered users, who in this example are “Johnny,” “Alberta,” “Helen,” and “Hal.” Each name 605 may also serve as a user-selectable icon. Associated with each registered user's name is a numeral that represents the number of unread messages addressed to the respective user that are located on mail server system 200. For example in FIG. 6, “Johnny,” “Alberta,” “Helen,” and “Hal,” have 10, 0, 3, and 0 unread messages, respectively. Window 600 also includes a text box 610 in which a user can enter his or her password. In some embodiments of the invention the window 600 will only appear on the display of the user interface device when the user activates the e-mail program module 36 via an appropriate input device. In other embodiments the window will appear as a default screen on the display of the user interface device. The latter embodiment may be particularly appropriate when the user interface device is an Internet appliance that is not required to undergo an initial boot-up procedure.

In some embodiments of the invention the status information need not be visually conveyed on a display, but may be conveyed in any of a number of different ways. For example, an audio indicator or a visual signal such as an indicator light may be employed. Of course, the present invention also contemplates systems in which the status information is conveyed in a combination of different ways.

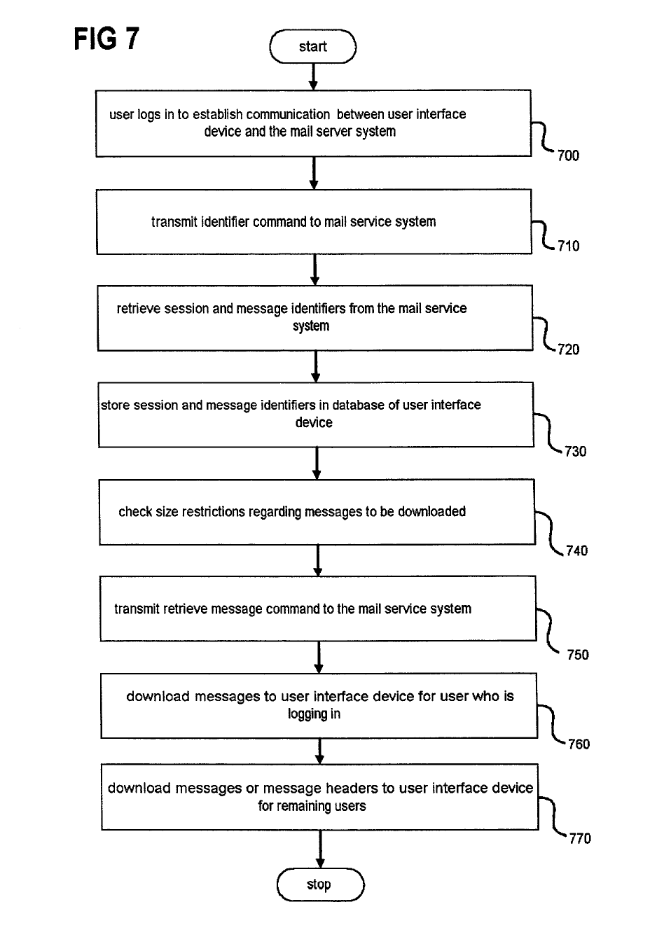

FIG. 7 is a flowchart illustrating a representative example of a communication session in accordance with the present invention between mail system 200 and user interface device 300. A user begins the login process at step 700 by selecting his or her name with a mouse click or the like. Next, the user enters his or her password into text box 610. Finally, the user selects the login icon 620 to establish communication with the mail server so that the download process may begin. The login procedure notifies the mail system 200 that a group of registered users are requesting e-mail information and that the particular registered user who is conducting the communication session is requesting his or her e-mail to be downloaded.

Continuing with FIG. 7, the download operation begins when the user interface device 300 transmits an identifier command to system 200 at step 710. The identifier command requests identification information for both the messages to be downloaded for the user who is logging in and for the messages of the remaining registered users. At step 720, in response to the identifier command, the user interface device 300 retrieves from mail system 200 the session identifier and the requested message identifier for the first message on the system 200. The message and session identifiers are stored in database 39 at step 730. If there are more messages on the system 200, this process is repeated for the additional messages to complete the initial download operation. Once the message and session identifiers have been populated in the database 39 for each message, the user interface device 300 checks for a size restriction in connection with downloading messaging from the mail system 200 at step 740. Once again, in this example, the user interface device 300 does not find a size restriction set by the user and consequently, at step 750 the user interface device 300 transmits a retrieve command to the mail system 200 so that the messages for the registered user who is logging in are downloaded into the local message store 38 at step 760. Next, the e-mail of the registered users who are not logging in may be downloaded to local message store 38 at step 770. In this case, however, the messages cannot be accessed until the appropriate password is entered for each registered user who has received messages. Rather, only status information such as the number of unread messages are displayed for each user in window 600, as determined from the number of message identifiers that have been received and stored in database 39. In some embodiments of the invention only the message identifiers and not the messages themselves are downloaded at step 770 for those registered users not logging in. In this case only when the appropriate password is entered will the messages themselves actually be downloaded. This embodiment of the invention may be particularly advantageous when the user interface device has limited local storage capabilities.

In yet other embodiments of the invention the message identifiers as well as additional information such as the message headers are downloaded for those registered users not logging in. This embodiment of the invention may be particularly advantageous when the status information to be displayed on the user interface device is not limited to the number of unread messages, but includes additional information such as the name of the senders, the time at which the messages were received by the e-mail server system, and/or the priority of the messages, for example.

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data formats and protocols, any formats or protocols may suffice. Moreover, while some of the embodiments describe specific embodiments of computer, clients, servers, etc., other types may be employed by the invention described herein. Furthermore, these examples should not be interpreted to limit the modifications and variations of the invention covered by the claims but are merely illustrative of possible variations.

What is claimed is:

1. A method for managing electronic mail messages to be received over a distributed computer network by a plurality of users, said method comprising the steps of:
retrieving over the distributed computer network electronic mail messages addressed to a first of said plurality of users; and
retrieving over the distributed computer network status information regarding any unread electronic mail messages addressed to remaining ones of the plurality of users.

2. The method of claim 1, wherein the step of retrieving electronic mail messages includes the step of logging onto the distributed computer network to establish communication with a server on which said electronic mail messages are stored.

3. The method of claim 2, wherein the step of logging onto the distributed computer network is performed only by said first of the plurality of users.

4. The method of claim 1, wherein said retrieving steps are performed on a user interface device and said plurality of users have been previously registered as users of said user interface device.

5. The method of claim 1, wherein said status information includes a representation of the number of unread electronic mail messages available for the remaining ones of the plurality of users.

6. The method of claim 5, wherein said status information further includes an identifier of the sender of each of the unread electronic mail messages.

7. The method of claim 1, further comprising the step of displaying said status information on a display of a user interface device.

8. The method of claim 5, further comprising the step of displaying said status information on a display of a user interface device.

9. The method of claim 8, wherein said plurality of users have been previously registered as users of said user interface device and said displaying step includes the step of displaying a window that identifies said previously registered users.

10. The method of claim 9, wherein said identification of previously registered users includes a selectable icon for each of the previously registered users.

11. The method of claim 10, wherein said selectable icons specify the respective names of the previously registered users.

12. The method of claim 10, further comprising the step of selecting one of the selectable icons to initiate a login procedure for establishing communication with the distributed computer network.

13. The method of claim 2, wherein the step of logging onto the distributed computer network includes the step of entering a password into a text-box of the window.

14. The method of claim 12, wherein the step of establishing communication with the distributed computer network includes the step of entering a password into a text-box of the window.

15. A computer-readable storage medium for storing data for access by a computer program being executed on a user interface device, comprising:
a first data structure stored on said medium for retrieving over a distributed computer network electronic mail messages addressed to a first one of a plurality of users; and
a second data structure stored on said medium for retrieving over the distributed computer network status information regarding any unread electronic mail messages addressed to remaining ones of the plurality of users.

16. The medium of claim 15, wherein said first data structure includes a pointer to a window to be displayed on the user interface device.

17. The medium of claim 15, wherein said first data structure is operative to retrieve electronic mail messages after logging onto the distributed computer network to establish communication with a server on which said electronic mail messages are stored.

18. The medium of claim 17, wherein said first data structure is operative to perform said retrieving steps after the step of logging onto the distributed computer network is performed by only said first of the plurality of users.

19. The medium of claim 15, wherein said first and second data storage structures are operative on a user interface device and said plurality of users have been previously registered as users of said user interface device.

20. The medium of claim 15, wherein said status information includes a representation of the number of unread electronic mail messages available for the remaining ones of the plurality of users.

21. The medium of claim 20, wherein said status information further includes an identifier of the sender of each of the unread electronic mail messages.

22. The medium of claim 15, further comprising a third data structure for displaying said status information on a display of a user interface device.

23. The medium of claim 22, wherein said status information is displayed on a display of a user interface device.

24. The medium of claim 16, further comprising a third data structure for displaying said status information in said window.

25. The medium of claim 24, wherein said plurality of users have been previously registered as users of said user interface device and said window identifies said previously registered users.

26. The medium of claim 25, wherein said identification of previously registered users includes a selectable icon for each of the previously registered users.

27. The medium of claim 26, wherein said selectable icons specify the respective names of the previously registered users.

28. The medium of claim 27, wherein said selectable icons are operative to initiate a login procedure for establishing communication with the distributed computer network.

29. The medium of claim 28, wherein said window includes a text-box for entering a password for completing the login procedure.

30. A system containing a user interface for recipients of electronic mail messages, comprising:
a processing unit, system memory, and an input/output device;
a system bus coupling said processing unit, said system memory, and said input/output device; and
an electronic mail program module located in said system memory operative to: (1) retrieve over a distributed computer network electronic mail messages addressed to a first one of a plurality of users; and (2) retrieve over the distributed computer network status information regarding any unread electronic mail messages addressed to remaining ones of the plurality of users.

31. The system of claim 30, further comprising a local message store operative to store the electronic mail messages received over the distributed computer network; and a database operative to store message-related information received over the network.

32. The system of claim 30, wherein said input/output device includes a display and said system memory has a first data structure that includes a pointer to a window to be displayed on the display.

33. The system of claim 30, wherein said system memory includes a first data structure that is operative to retrieve electronic mail messages after logging onto the distributed computer network to establish communication with a server on which said electronic mail messages are stored.

34. The system of claim 33, wherein said first data structure is operative to retrieve the electronic mail messages of said first one of the plurality of users and said status information after only said first of the plurality of users has logged in to the network.

35. The system of claim 30, wherein said plurality of users have been previously registered as system users and said status information includes a representation of the number of unread electronic mail messages available for the remaining ones of the plurality of users.

36. The system of claim 30, wherein said status information further includes an identifier of the sender of each of the unread electronic mail messages.

37. The system of claim 32, wherein said plurality of users have been previously registered as system users and said window identifies said system users.

38. The system of claim 37, wherein said identification of said system users includes a selectable icon for each of the system users.

39. The system of claim 38, wherein said selectable icons specify the respective names of the system users.

40. The system of claim 39, wherein said selectable icons are operative to initiate a login procedure for establishing communication with the distributed computer network.

41. The system of claim 40, wherein said window includes a text-box for entering a password for completing the login procedure.
